(19) United States
(12) Patent Application Publication
(10) Pub. No.: US 2008/0180034 A1
(43) Pub. Date: Jul. 31, 2008

(54) BLINKING LIGHT STRING

(76) Inventor: Kuo-An Pan, Hong Kong (CN)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/954,052

(22) Filed: Dec. 11, 2007

(30) Foreign Application Priority Data
Jan. 31, 2007 (CN) 20118426.2

(51) Int. Cl. F21S 4/00

(52) U.S. Cl. 315/185 S

(57) ABSTRACT

A twinkling light string includes an AC plug configured to connect to an AC power supply and an AC plug receiver is configured to extend the twinkling light string by receiving another AC plug. A set of light branches including one light branch or a plurality of light branches connected in parallel, each of the light branches including a plurality of LED light bulbs connected in series, at least one of the LED light bulbs including two light emitting diodes, the two light emitting diodes are configured to twinkle under control of oscillating circuitry. Rectifying circuitry is located between the AC plug and the set of light branches. The rectifying circuitry is configured to convert inputted alternating current to direct current and is configured to power the light branches or a plurality of light branches connected in parallel by the direct current.

### CROSS REFERENCE TO RELATED APPLICATIONS

This patent specification is based on Chinese Patent Application No. 200720118426.2 filed on Jan. 31, 2007 in the Chinese Patent Office, the entire contents of which are incorporated by reference herein.

### BACKGROUND OF THE INVENTION

1. Field of the Invention

The present invention is generally related to a light string used for decorative purposes during holidays and festivals. More particularly, the present invention relates to a twinkling light string.

2. Description of the Related Art

Conventional twinkling light strings utilize a twinkling light source, such as a twinkling incandescent bulb. The twinkling incandescent bulb twinkles based on the principle of fluctuations in the conduction path during normal and high temperature changes between a filament and a metal element in the incandescent bulb. When the filament is electrified, the filament is heated up by electrical energy, thus causing the filament to glow. The metal element deforms because of the increased temperature, causing the metal element to separate from the filament, creating a short circuit, which shuts off power to the incandescent bulb. The metal element cools down due to the lack of heat, and reconnects the circuit electrifying the filament once again and causing the filament to glow. Therefore a twinkling effect is achieved as the filament periodically contacts with the metal element.

However, traditional twinkling light strings and associated light ornaments incorporating traditional twinkling light strings twinkle randomly in an orderless frequency, due to the different rates of declining performance characteristics of the various incandescent bulbs. Consequently, traditional twinkling light strings are not capable of performing more sophisticated ornamental functions.

Moreover, traditional twinkling light strings distributed in the present market include a DC (direct current) outlet. A sublevel light string can be series connected at the DC outlet. The power consumption of the following sublevel light strings can cause the first-level light string to overload. In an instance where the first-level light string burns out, a fire hazard may result. In light of the foregoing, there is a need to improve conventional twinkling light strings.

### SUMMARY OF THE INVENTION

A twinkling light string includes an AC plug configured to connect to an AC power supply and an AC plug receiver is configured to extend the twinkling light string by receiving another AC plug. A set of light branches including one light branch or a plurality of light branches connected in parallel, each of the light branches including a plurality of LED light bulbs connected in series, at least one of the LED light bulbs including two light emitting diodes, the two light emitting diodes are configured to twinkle under control of oscillating circuitry. Rectifying circuitry is located between the AC plug and the set of light branches. The rectifying circuitry is configured to convert inputted alternating current to direct current and is configured to power the light branches or a plurality of light branches connected in parallel by the direct current.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an electrical schematic diagram of a twinkling light string in accordance with an embodiment of the present invention incorporating oscillation circuitry;

FIG. 2 is an electrical schematic diagram of the oscillation circuitry of an embodiment of the present invention;

FIG. 3 is a front view of an embodiment of the present invention; and

FIG. 4 is a rear view of an embodiment of the present invention.

### DETAILED DESCRIPTION OF THE PREFERRED EMBODIMENTS

Referring now to the drawings, wherein like reference numerals designate identical or corresponding parts throughout the several views.

The present inventions have several features, no single one of which is solely responsible for its desirable attributes. Without limiting the scope of the invention as expressed by the claims which follow, its more prominent features will now be discussed briefly. After considering this discussion, one will understand how the present inventions provide several advantages over traditional twinkling light strings.

Accordingly, one object of the present invention in accordance with the twinkling light string is to provide a twinkling light string capable of stable twinkling in an uniform frequency and with a better ornamental effect.

To achieve the above objects and in accordance with the purpose of the embodiments of the invention as embodied and broadly described herein, an embodiment of a twinkling light string comprising an AC plug, an AC plug receiver, a set of light branches including one branch light or a plurality of light branches connected in parallel, and rectifying circuitry arranged between the AC plug and the set of light branches. The AC plug is adapted for connecting to an AC power supply. The AC plug receiver connects the AC plug by an AC line, and extends the twinkling light string by connecting the light string to another light string. Each of the light branches includes a plurality of series connected LED light bulbs, at least one of the LED light bulbs includes two light emitting diodes, the two light emitting diodes twinkle under the control of an oscillating circuitry. The rectifying circuitry is arranged between the AC plug and the set of light branches, and converts inputted alternating current to direct current. The light branch or a plurality of light branches connected in parallel, are powered by direct current. At least one voltage-limiting resistor is engaged in at least one of the light branches, the at least one voltage-limiting resistor is connected with the LED light bulbs of the light branches in series. The at least two light emitting diodes can be in different colors or the same color.

Another embodiment of a twinkling light ornament includes at least one outer ornament, and at least one twinkling light string fixed on the at least one outer ornament. The at least one twinkling light string includes a light branch or a plurality of light branches connected in parallel. Each of the light branch includes a plurality of series connected LED light bulbs, the light bulbs are scattered around the at least one outer ornament, at least one of the LED light bulbs includes two light emitting diodes, the two light emitting diodes twinkle under control of oscillating circuitry. The twinkling light string further includes an AC plug, an AC plug receiver, and rectifying circuitry. The AC plug is adapted for connecting to an AC power supply, the rectifying circuitry adapted to convert inputted alternating current to direct current, is arranged between the AC plug and the light branch or a plurality of light branches connected in parallel. The light branch or a plurality of light branches connected in parallel are powered by the direct current. The AC outlet connects the AC plug by an AC line adapted to extend the twinkling light string. At least one voltage-limiting resistor is engaged in at least one of the light branches, the at least one voltage-limiting resistor is connected in series with the LED light bulbs of the light branch. The at least two light emitting diodes are configured in different colors or the same color. In one embodiment of the present invention, the at least one outer ornament is integrally formed. In another embodiment, the at least one outer ornament is respectively formed, and movable alone or movable relative to others under the action of a drive device.

The effective result of one embodiment of the present invention is as follows: 1) The light branches of the present invention includes a plurality of series connected LED light bulbs, at least one of the LED light bulbs includes two light emitting diodes, the two light emitting diodes twinkle under control of an oscillating circuitry, which optimizes the ornamental effect. 2) The at least two light emitting diodes are configured in different colors or the same color, so as to present more abundant color and offer various color changes. 3) The twinkling light string can be applied in different ornaments designed for every festival article. 4) The outlet of the twinkling light string is an AC (alternating current) outlet, minimizing load impact from the sublevel twinkling light string upon the first level, thereby creating a safer device.

Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

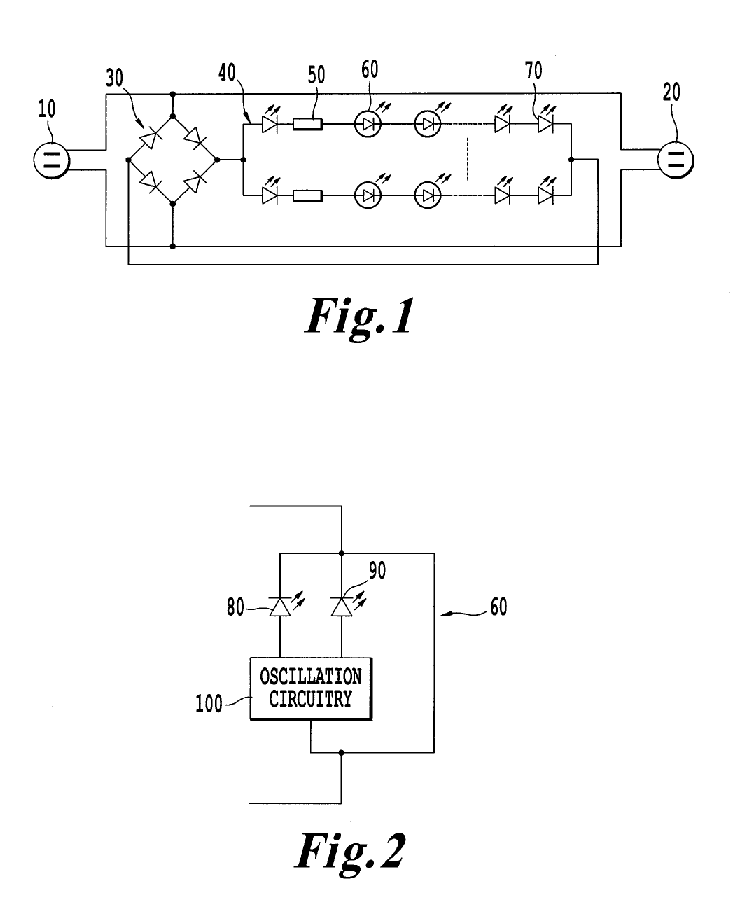

Referring to FIG. 1, a twinkling light string including an AC plug 10, an AC plug receiver 20 connected to the AC plug 10, a set of light branches 40, and rectifying circuitry 30 arranged between the AC plug 10 and the set of light branches 40. The AC plug 10 is configured to connect to an AC power supply, such as a utility power line (110 volts in the US or 220 volts in China). The AC plug receiver 20 connects the AC plug 10 by an AC line, in order to extend a sublevel of the twinkling light string when receiving a second AC plug from a second string.

The set of light branches 40 can incorporate one light branch or a plurality of light branches connected in parallel. For illustrative purposes, the set of light branches 40 of the present embodiment incorporates a plurality of light branches. Each light branch includes a plurality of ordinary LED light bulbs 70 connected in series and a plurality of twinkling light bulbs 60. The ordinary LED light bulbs 70 are connected in series with the twinkling light bulbs 60.

The rectifying circuitry 30 can be, for example, located between the AC plug 10 and the set of light branches 40. For example, the rectifying circuitry 30 can be in parallel with the AC plug 10, and in series with the set of light branches 40. The rectifying circuitry 30 is designed to convert alternating current to direct current. The set of light branches 40, i.e. the plurality of light branches connected in parallel are powered by direct current from the rectifying circuitry 30. Thus minimizing the impact of the load of the sublevel twinkling light strings upon the first level light string, while creating a safer environment.

Referring now to FIG. 2, the twinkling light bulbs 60 are configured with two light emitting diodes, a first light emitting diode 80 and a second light emitting diode 90. The first and second light emitting diodes 80, 90 twinkle under the control of oscillation circuitry 100. In the present embodiment, the oscillation circuitry 100 can use, for example, standard field effect transistor (CMOS) oscillating circuitry.

In order to provide the set of light branches 40 with a stable flow of current, each light branch in the set of light branches 40 can be engaged with a voltage-limiting resistor 50 in accordance with specific electrical conditions. The voltage-limiting resistor 50 can be positioned in series with the ordinary or twinkling LED light bulbs 60, 70 in the light branch. The voltage-limiting resistor 50 can be, for example, a fixed value resistor or a variable value resistor.

The at least one twinkling light string includes a set of light branches 40 having one light branch or a plurality of light branches connected in parallel. Each light branch includes a plurality of ordinary LED light bulbs 70 connected in series and a plurality of twinkling light bulbs 60. The ordinary LED light bulbs 70 are in series with the twinkling light bulbs 60. The ordinary light bulbs 70 and the twinkling light bulbs 60 are scattered around the at least one outer ornament. The twinkling light bulbs 60 include first and second light emitting diodes 80, 90 and the first and second light emitting diodes 80, 90 alternatively twinkle under the control of oscillation circuitry 100.

In an embodiment of the present invention, in order to achieve better ornamental effects, the first and second light emitting diodes 80, 90 can be in any color (e.g., blue, red, green etc.) and each can be different colors or both the same color.

An embodiment of the present invention relates to a twinkling ornament. The twinkling ornament is an application of the twinkling light string. The twinkling ornament can include at least one outer ornament and at least one twinkling light string fixed on the at least one outer ornament.

The outer ornament of an embodiment of the present invention can be designed in various shapes or representative models of different personae, objects, etc., such as a Christmas tree or Santa Claus. In an embodiment of the present invention, the outer ornaments can be integrally formed, and non-movable relative to other outer ornaments. Thus, the outer ornaments can be designed to provide stationary ornamental effects.

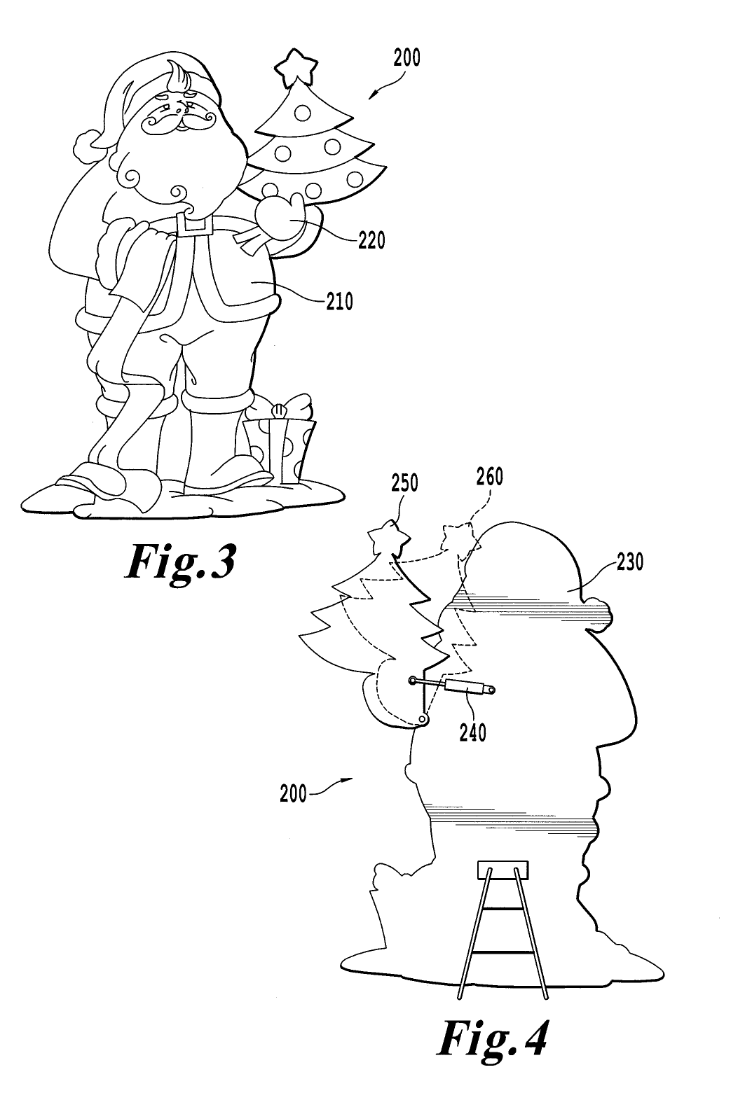

In another embodiment of the present invention, the outer ornaments can be configured to include an active ornament and an inactive ornament, so as to replicate a living or moving ornamental item. The active ornament is engaged with the inactive ornament and independently moves, rotates, or reciprocates along a predetermined route driven by a drive device, e.g. a motor. An illustrative example of this principle is an ornamental representation as shown in FIG. 3. FIG. 3 shows a Santa Claus 200 displayed by outer ornaments forming the main body of the Santa Claus, i.e. the inactive ornament 210, and a hand of the Santa Claus holding a Christmas tree displayed by the active ornament 220. The active ornament 220, i.e., the hand and tree, can rock back and forth under the control of a motor 240 relative to the inactive ornament 220, i.e. the main body of the Santa Claus.

FIG. 4 shows a back view of the ornamental representation of Santa Claus 200. FIG. 4 also shows a the active ornament 220, i.e., the hand and tree, in a first position 250. The active ornament 220 can be moved to a second position 260 under the power of the motor 240, which is attached to the back portion 230 of the Santa Claus 200.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Obviously, numerous modifications and variations of the present invention are possible in light of the above teachings. It is therefore to be understood that within the scope of the appended claims, the invention may be practiced otherwise than as specifically described herein.

1. A twinkling light string, comprising:
an AC plug configured to connect to an AC power supply;
an AC plug receiver configured to extend the twinkling light string by receiving another AC plug;
a set of light branches including one light branch or a plurality of light branches connected in parallel, each of the light branches including a plurality of LED light bulbs connected in series, at least one of the LED light bulbs including two light emitting diodes, the two light emitting diodes configured to twinkle under control of oscillating circuitry; and
rectifying circuitry located between the AC plug and the set of light branches, the rectifying circuitry configured to convert inputted alternating current to direct current and configured to power the light branch or the plurality of light branches connected in parallel by the direct current.

2. The twinkling light string as in claim 1, wherein at least one voltage-limiting resistor is included in at least one of the light branches, the at least one voltage-limiting resistor connected in series with the LED light bulbs in a light branch.

3. The twinkling light string as in claim 1, wherein the at least the two light emitting diodes are a different color.

4. A twinkling light ornament, comprising:
at least one outer ornament; and
at least one twinkling light string fixed on the at least one outer ornament, wherein the at least one twinkling light string includes:
a set of light branches including one light branch or a plurality of light branches connected in parallel, each of the light branches including a plurality of LED light bulbs connected in series, the LED light bulbs scattered around the at least one outer ornament, at least one of the LED light bulbs including two light emitting diodes, the two light emitting diodes configured to twinkle under control of oscillating circuitry.

5. The twinkling light string as in claim 4, wherein the twinkling light string further comprises an AC plug, an AC plug receiver, and rectifying circuitry.

6. The twinkling light string as in claim 5, wherein the AC plug is configured to connect to an AC power supply, the rectifying circuitry is configured to convert input alternating current to direct current and is located between the AC plug and a set of light branches, the set of light branches includes one light branch or the plurality of light branches connected in parallel, the light branch or the plurality of light branches are connected in parallel and are powered by the direct current, and the AC plug receiver is configured to extend the twinkling light string by receiving a second AC plug.

7. The twinkling light string as in claim 4, wherein at least one voltage-limiting resistor is included in at least one of the light branches, the at least one voltage-limiting resistor connected in series with the LED light bulbs in a light branch.

8. The twinkling light string as in claim 7, wherein at least two light emitting diodes are a different color.

9. The twinkling light string as in claim 7, wherein the at least one outer ornament is integrally formed.

10. The twinkling light string as in claim 7, wherein the at least one outer ornament is configured to move independently or to move relative to other ornaments under the power of a drive device.

11. A twinkling light string, comprising:
an AC plug configured to connect to an AC power supply;
an AC plug receiver configured to extend the twinkling light string by receiving another AC plug;
a set of light branches including one light branch or a plurality of light branches connected in parallel, each of the light branches including a plurality of LED light bulbs connected in series, at least one of the LED light bulbs including two light emitting diodes;
means for controlling the twinkling of the two light emitting diodes; and
rectifying circuitry located between the AC plug and the set of light branches, the rectifying circuitry configured to convert inputted alternating current to direct current and configured to power the light branch or the plurality of light branches connected in parallel by the direct current.

12. The twinkling light string as in claim 11, wherein at least one voltage-limiting resistor is included in at least one of the light branches, the at least one voltage-limiting resistor connected in series with the LED light bulbs in a light branch.

13. The twinkling light string as in claim 11, wherein at least the two light emitting diodes are a different color.

14. A twinkling light ornament, comprising:
at least one outer ornament; and
at least one twinkling light string fixed on the at least one outer ornament, wherein the at least one twinkling light string includes:
a set of light branches including one light branch or a plurality of light branches connected in parallel, each of the light branches including a plurality of LED light bulbs connected in series, the LED light bulbs scattered around the at least one outer ornament, at least one of the LED light bulbs including two light emitting diodes; and
means for controlling the twinkling of the two light emitting diodes.

15. The twinkling light string as in claim 14, wherein the twinkling light string further comprises an AC plug, an AC plug receiver, and rectifying circuitry.

16. The twinkling light string as in claim 15, wherein the AC plug is configured to connect to an AC power supply, the rectifying circuitry is configured to convert input alternating current to direct current and is located between the AC plug and a set of light branches, the set of light branches includes one light branch or the plurality of light branches are connected in parallel, the light branch or a plurality of light branches connected in parallel and are powered by the direct current, and the AC plug receiver is configured to extend the twinkling light string by receiving a second AC plug.

17. The twinkling light string as in claim 14, wherein at least one voltage-limiting resistor is included in at least one of the light branches, the at least one voltage-limiting resistor is connected in series with the LED light bulbs in a light branch.

18. The twinkling light string as in claim 17, wherein at least two light emitting diodes are a different color.

19. The twinkling light string as in claim 17, wherein the at least one outer ornament is integrally formed.

20. The twinkling light string as in claim 17, wherein the at least one outer ornament is configured to move independently or to move relative to other ornaments under the power of a drive device.
